(19) United States
(12) Patent Application Publication
(10) Pub. No.: US 2008/0235043 A1
(43) Pub. Date: Sep. 25, 2008

(54) System and Method For Communicating Messages Between Users of a System

(76) Inventors: Alexander Goulandris, London (GB); Toufique Haron, Wallingford, PA (US)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 11/909,946

(22) PCT Filed: Mar. 29, 2003
(86) PCT No.: PCT/GB06/01146

§ 371 Date: Apr. 25, 2008

(30) Foreign Application Priority Data
Mar. 29, 2005 (EP) 05251919.6

(51) Int. Cl. G06Q 99/00; H04L 9/32

(52) U.S. Cl. 705/1; 726/4

(57) ABSTRACT

A distributed system for communicating messages between registered users of the system, each registered user communicating with the system via a user terminal, the messages relating to an original electronic document that is stored on the system and associated with one of the user terminals, the system comprising a plurality of registries, each registry having a mutual trust relationship with each of the other registries and each registry being associated with one or more user terminals; wherein each registry is connectable to a data communications network, and comprises a processing means arranged to validate the eligibility of each of its registered users' user terminals to send or receive a message relating to the stored electronic document, the processing means further being arranged to notarise a message sent from or received by the user terminal of one of its one or more registered users, the notarisation indicating the validity of the message relating to the stored document.

### FIELD OF INVENTION

The present invention relates to a system and method for communicating messages between uses of a system. More particularly, the present invention relates to an electronic system for the storage of documentation and for the communication of messages between users of the system. The invention also relates to a method of storing electronic documents and communicating messages on a system. The invention further relates to a system and method for verifying the identity of users of an electronic system. In particular, but not exclusively, the invention may be applied to electronic transaction environments, such as cargo and commodity trading, trade finance and shipping.

### BACKGROUND OF THE INVENTION

Problems related to electronic systems and methods of document exchange and trading are described below with particular reference to Bills of Lading used in the shipping industry. It will, however, be appreciated that the Bill of Lading is used by way of example only and the discussion does not exclusively apply to such systems.

Generally speaking, a paper Bill of Lading is issued by a transportation carrier to the shipper (i.e., seller of the goods or exporter) acknowledging that the carrier has received the goods for shipment and that these goods have been placed on board a particular vessel, bound for a named destination.

The Bill of Lading typically has three functions, namely that:
1. It describes the shipment, i.e., it identifies the shipper, receiver, pick up point/port and delivery point/port and describes the goods, for example, the quantity and quality of the goods and any remarks by the ship's Captain about damage;
2. It outlines the terms of the contract of carriage;
3. It constitutes title of the goods, when the Bill of Lading is negotiable.

A negotiable Bill of Lading is typically drafted by either the carrier or the shipper/seller. These parties then typically send the draft to one another for review and approval, before the original Bill is issued by the carrier or his agent.

The issued negotiable Bill of Lading is then forwarded to the shipper who, depending on the terms of sales, will either forward it to a bank (if a documentary credit is used to finance the trade) or send it direct to the buyer (if the sale is, for instance, on account).

A negotiable Bill of Lading is frequently referred to as a “To Order” bill because the goods are to be delivered by the ship's Captain to whichever party the To Order Party so designates. A negotiable bill may therefore be sold en route by endorsing the back of the bill and physically handing over transfer to the new owner or holder. If no party is defined in the To Order Party section of the bill, it will be deemed a bearer bill. However, the bill may later become a To Order bill if that section is filled out.

In cases involving documentary credits, a letter of credit is set up by the receiver with his bank, the issuing bank, before the goods are shipped. The issuing bank sends the letter of credit to the shipper's bank, the advising bank. The shipper's bank then advises the shipper that the letter of credit has been established. The shipper then ships the goods, and receives in return the Bill of Lading, which he forwards to his bank, along with other pertinent shipping documents (customarily the bill will only be sent to the bank, and it will be endorsed to the buyer). The advising bank and the issuing bank reconcile the documents to ensure that they comply with the terms of the letter of credit. Assuming the documents comply, the advising bank pays the shipper and the issuing bank debits the buyer and releases the documents to him so that he may receive the goods or trade them further. In certain commodities, such as crude oil, this sales process can be repeated many times over until it arrives in the hand of the final buyer, i.e., the receiver of the goods.

When the vessel arrives at the discharge port, the receiver will present the original Bill of Lading to the ship's captain, who will mark the Bill of Lading with the terms “voyage accomplished” after delivering the goods to the receiver. At this point the Bill of Lading will effectively be exhausted. A simplified illustration of the flow of goods and funds is shown in FIG. 1.

There are a several different types of Bills of Lading as outlined below:

i) Inland—Used when transporting goods overland. Through Bill of Ladings are used to cover voyages entailing both domestic and international transport of goods.

ii) Ocean—Used for transporting merchandise to a specified foreign market overseas.

iii) Air Waybill—A non-negotiable Bill of Lading (as described below) which covers goods carried by air transportation

iv) Through (Multimodal)—Issued to covering an entire voyage involving several different modes of transportation, i.e., carriage by land, sea or air

v) Straight (Non-negotiable)—If issued, the carrier must deliver the goods only to the consignee named in the Bill of Lading. A straight Bill of Lading therefore acts both as a receipt of goods and as an agreement to transport these goods.

vi) Negotiable—If a negotiable Bill of Lading is issued, the goods must be delivered to shipper's order, rather than to a specific, named consignee, as ownership of the goods and the right to re-route the shipment remains with the person who ‘holds’ the Bill of Lading. For example, negotiable Bill of Ladings are generally required when payment for the goods is made through banking channels, using a letter of credit. The exporter must endorse the Bill of Lading and deliver it to the bank in order to receive payment.

vii) Received—Acknowledges that the goods have been received by the carrier for shipment. It does not prove that they have been shipped, as the goods could be on the dock or in a warehouse.

viii) Onboard (Shipped)—Confirms the fact that the goods have been shipped with the pre-printed wording or a notation stating “on board” or “shipped on board”

ix) Claused—Includes a notation by the ship's captain identifying that the goods are damaged or being carried in a manner in which they might well become damaged (i.e., they are being shipped on the deck of the vessel)

x) Clean (Clean on board)—Bill is marked as “Clean on Board” and certifies that the goods are undamaged

xi) Short Form—The terms of the contract of carriage are not printed on the back of the bill, in order to save on printing costs.

xii) Long Form—The terms of the contract of carriage are printed on the back of the bill.

xiii) Sea Waybill—Although not strictly a Bill of Lading, a sea waybill acts very similarly to a Straight Bill of Lading.

While the Bill of Lading's multipurpose functionality makes it one of the most important shipping documents, numerous other documents are created when shipping goods by land, sea and/or air. To make matters more complicated, many similar documents are created if the transportation is multimodal, i.e., by truck then ocean vessel then rail, repeating information.

A list of some of the additional documents which might be created and the entities preparing them is outlined below:

| Documents | Entities Creating Documents |
|---|---|
| Commercial Invoice | Trucker |
| Pro Form Invoice | Ocean Carrier |
| Packing List | Railroad Company |
| Purchase Invoice | Airline |
| Warehouse Receipt | Customs Broker |
| Certificate of Origin | Freight Forwarder |
| Certificate of Quality | Exporter |
| Certificate of Quantity | Importer |
| Advanced Cargo Manifest | Cargo Surveyor |
| Manifest | Warehouse |
| Dock Receipt | Government |
| Customs Export Declaration | Bank |
| Trucker Interchange Receipt | |
| Letter of Credit | |

As explained above, goods are frequently shipped using a combination of different forms of transportation. Each of these carriers issues their own form of trade documents, in addition to the numerous ancillary documents, which are prepared, such as warehouse receipts.

As a result, a single cargo shipment results in the creation of 20-30 distinct trade documents, each of which incorporates similar and frequently overlapping information. Due to the overlap, carriers typically copy information from one paper document to another. This retyping of information leads to multiple intra-document errors, which in turn results in delays, as processing of conflicting documents takes time.

However, despite their widespread use, larger problems arise from the very use of a paper Bill of Lading. Firstly, a ship will frequently complete her voyage before the original Bill of Lading has reached the place or port of destination. This problem has been exacerbated since the 1980s, when banks have used the Bill of Lading as a source of security in trade finance transactions, predominantly where documentary credits, i.e., letters of credit, are used. The requirement that the Bill of Lading pass to banks, in addition to travelling between the seller and the buyer, adds to the delay in the shipping document arriving at the place or port of discharge.

This delay in the arrival of the cargo documentation can place a carrier in a difficult position. Either the carrier is forced to refuse to hand over the goods and thereby incur storage costs or the carrier has to hand over the goods without a Bill of Lading (an event which nullifies his insurance policy). This second course of action can expose the carrier to legal claims from the genuine Bill of Lading holder, who may later appear and demand the goods.

In addition, these delays (i) increase working capital costs as inventory levels must be higher and trade financing is longer than necessary; (ii) increase legal risk to ship owners who deliver cargo without the original Bill of Lading, and; (iii) reduce equipment utilization as ships and containers wait for documentation before being unloaded and create enormous document management costs.

Secondly, the industry tradition of utilizing unrecorded physical possession of a paper Bill of Lading to demonstrate the legal ownership of the underlying goods is fraught with fraud risks. Blank Bills of Lading can often be stolen relatively easily thereby allowing the content of a genuine bill copied.

Thirdly, existing fraud problems are exacerbated by the industry's attempts to solve the issue of delays using bills issued in triplicate (wherein three originals bills are issued and signed). The first original is sent to the shipper (the exporter). The second is sent straight to the shipper's bank, in order to speed up the processing of any documentary credit. The last original is kept by the ship's Captain to compare with the bill presented at the discharge port.

As described in more detail below a number of attempts have been made to replace paper based Bills of Lading with electronic systems. However, the potential for an electronic Bill of Lading to be easily reproduced has slowed the adoption of such systems and has led to systems that provide only partial solutions to the above problems.

A further issue to be considered when developing an electronic based system is the manner in which transactions on title documents, such as Bills of Lading, is undertaken.

For example, while conducting electronic transactions, a sender (S) often wants to securely send a message (M) to a recipient (R). However, the sender (S) may not want to disclose the full contents of the message (M) to the recipient (R). Notwithstanding this problem, the recipient (R) needs to be guaranteed as to the validity of the message's full contents (M). In addition, should a dispute occur involving the message (M), the recipient (R) must be able to retrieve the full message contents (M) with permission from the sender (S).

A practical situation where this may be applicable is in the electronic transfer of title in commodity trading. Frequently, commodity traders engage in arbitrage, a practice in which they buy commodities from a supplier for a low price and sell the commodity to a buyer at a higher price in trades where they have a unique knowledge of the requirements of the buyer and the seller. In electronic commodity trading systems, it is often necessary to hide the identity of the supplier from whom the trader has originally obtained the goods, while at the same time, guaranteeing the buyer that the trader actually holds proper title to the goods.

If the identity of the supplier is revealed to the buyer, the buyer could buy the commodities directly from the supplier, thereby putting the trader out of business. Since a message transmission protocol with characteristics described above has not previously been available, commodity traders have been reluctant to adopt electronic commodity trading systems that transfer the title of goods electronically. Electronic systems have been devised that handle setting up trades, but the actual transfer of title is subsequently delegated to manual paper based processes.

Known prior art systems that attempt to deal with some of the above described issues are now briefly discussed.

To date the industry has attempted to solve some of the obvious inefficiencies by changing business practices, i.e., using non-negotiable Waybills which can be securely emailed or by utilizing Electronic Data Interchange (EDI) and various non-title e-document products.

However, this fragmented patchwork of solutions provides very limited cost savings primarily because they do not provide an electronic solution for the title document, (the Bill of Lading), and consequently fail to solve the overarching delay inefficiencies discussed above.

An overview of a number of prior solutions is below:

1) EDI: EDI messages contain the same data as a paper document, but reformatted into a computer friendly form. One of EDI's biggest problems is the time and expense of setting up and maintaining the system. Further, EDI cannot in itself provide an electronic Bill of Lading; it merely assists with data transfer between trade partners. As such, it can be useful for sending an electronic version of some of the less important supporting documentation, such as purchase orders.

2) Remote Printing: Several of the largest container shipping, various cargo portals and at least one software vendor provide remote Bill of Lading printing capabilities for their customers. This allows shipper users to print an original, carrier issued, Bill of Lading in their offices, thereby avoiding the first-step courier costs, from carrier to shipper. It also eliminates data re-entry of information from the booking note when drafting the bill. While remote printing assists in alleviating the delay inefficiencies, it only solves the problem for one step. The Bill of Lading must still be forwarded to each other party in the trade chain. In addition, because the original bill remains in paper form it is not possible to automate the letter of credit reconciliation step. Further it does not eliminate any of the fraud risks, as paper bills of lading are still used.

3) Electronic Waybills: Some solution providers have tried to solve the paper problem by using non-title electronic Waybills instead of bills of lading. While this can potentially solve the problem in certain trades such as intra-company-group shipping of containerized goods, it fails to meet the needs of bulk commodities which frequently trade at sea and therefore require the use of negotiable Bills of Lading.

4) SEADOCS: Chase Manhattan Bank and the Association of Oil Tankers Owners (INTERTANKO) set up SeaDocs in 1985. SeaDocs attempted to simulate negotiable documents by creating a central title registry. The system concentrated on the oil sector and required the deposit of the paper Bill of Lading with a central registry, where computerized records of all Bills of Lading and title changes were noted. At the discharge port, SeaDocs electronically delivered a copy of the negotiable Bill of Lading to the last endorsee thereby enabling it to obtain delivery from the carrier. However, the system used telex to transmit information which was not efficient or effective and was never commercially launched because it failed to obtain industry adoption.

5) GB 2,348,026 describes a centralized database system for supporting transactions in property referred to as “Bolero”.

An entity wanting to use the Bolero platform must first join the Bolero Association who thereafter act as agent for the users. There are two agreements in place—the first appoints Bolero as the agent, the second (the Rule Book) is between the users and relates to their agreement to utilize the electronic system.

Within the Bolero platform a carrier creates an electronic Bill of Lading, containing all the typical information associated with Bill of Ladings, in respect of cargo loaded on board. The carrier then chooses to include Hague or Hague-Visby rules, etc. and the e-Bill of Lading is then electronically sent by the carrier to Bolero who, on verifying the carrier's digital signature, transmits the document to the named shipper.

Thereafter title can be passed from a holder to a buyer by the process of novation and attornment—a process whereby the original contract of carriage between the cargo carrier and the cargo exporter is replaced by a new contract of carriage between the cargo carrier and the cargo importer. The title of e-bills are stored within a central title registry.

Each holder gives the Bolero registry electronic instructions, by way of a digital signature, with a private key stored on a smart card. Bolero acts on instructions by cancelling the title of the first holder (seller) and transferring it to the next holder (buyer). The obligations of the Bill of Lading are transferred by entering into an agreement which see those obligations taken on by the new holder.

When the current holder wants to negotiate on the Bill of Lading, he informs the carrier via the Bolero messaging system. The carrier then acknowledges that he holds the Bill of Lading for the latest holder. The new holder must accept that he is the new holder within 24 hours and thereby accept the new user-to-user agreement, which in turn releases the previous holder of his obligations. This acceptance can be made electronically, or by taking delivery of the cargo.

On completion of the voyage, the bill is surrendered and the Bolero Bill of Lading is placed in end status. The holder gives notice to the Bolero registry comprising instructions to surrender the Bill of Lading—the notice gives the identity of the user to whom the goods should be delivered. The carrier and the receiver must then agree on the method for confirming the receiver's identity at the quay side.

There are a number of disadvantages associated with the Bolero system. Firstly, the central registry provides a single point of attack for potential hackers due to its role as a single electronic vault holding title to millions (and potentially trillions) of dollars of cargo. Secondly, the central registry prohibits Bolero from offering a white-labeled version of the system, thus limiting the systems adoptability and scalability. Thirdly, the Bolero system offers only two types of user interface which increases costs and decreases user functionality. Finally, the system relies on proprietary data model standards, further increasing costs and reducing adoptability.

Existing methods of electronic message transmission only address the secure transmission of messages, i.e. privacy, integrity, and non-repudiation. Messages are generally encrypted and digitally signed using a Public-Key Infrastructure (PKI). However, such methods are unable to ensure the validity of the contents of a message without disclosing its contents to a recipient.

As far as the identity checking of users of electronic systems is concerned, most prior art systems use username/password methods or more sophisticated authentication methods such as two-factor authentication using security tokens or biometrics. Such authentication systems are susceptible to identity theft and/or the use of pseudonyms to fraudulently apply for a system user identity. In both cases, notwithstanding the accurate authentication of a user, the failure of the due diligence process in matching the actual user to his/her system ID can cause serious problems.

Prior art due diligence processes that are used to match system IDs to users tend to be limited. When an applicant signs up to a system environment, for example but not limited to, a computer program, system, network (such as a mobile, wireless, WiFi or satellite network), telephone exchange, portal, gateway, website, online market and/or exchange (“System Entity”), the applicant generally fills in an online application where he/she provides a proposed username and password. Many systems then authenticate that applicant either by linking them to a credit card used in the application, or simply by making them click on a link sent to the applicant at the email provided in his/her application.

In effect, the due diligence in matching the actual applicant to his/her system ID is extremely limited, if it exists at all. Further, the System Entity will frequently not be in a strong position to match the applicant to his/her system ID, as the System Entity may have no previous dealings or relationship with the applicant. Other users of the system generally rely entirely on the System Entity's due diligence.

### SUMMARY OF THE INVENTION

It is an object of the present invention to provide an electronic system for the storage of documentation and for the communication of messages between users of the system that substantially overcomes or mitigates some of the above mentioned problems.

According to a first aspect of the present invention, there is provided a distributed system for communicating messages between registered users of the system, each registered user communicating with the system via a user terminal, the messages relating to an original electronic document that is stored on the system and associated with one of the user terminals, the system comprising a plurality of registries, each registry having a mutual trust relationship with each of the other registries and each registry being associated with one or more user terminals; wherein each registry is connectable to a data communications network, and comprises a processing means arranged to validate the eligibility of each of its registered users' user terminals to send or receive a message relating to the stored electronic document, the processing means further being arranged to notarise a message sent from or received by the user terminal of one of its one or more registered users, the notarisation indicating the validity of the message relating to the stored document.

The present invention provides for a distributed communications system that can be used to exchange messages (e.g. transaction messages) relating to electronic documents that are stored within the system. In contrast to prior art approaches, the distributed system comprises a plurality of registries which interact with the user terminals of the registered users of the system—there is no centralised registry to which each user must register.

Each registry has a mutual trust relationship with other registries within the system. This allows messages originating from a user terminal associated with a first registry to be communicated and delivered as valid and authentic to a user terminal associated with a second registry.

The registries further comprise processing means capable of validating the eligibility of users to send/receive messages and also notarising the messages that they handle. This process means a recipient user of the system can be assured that the messages they receive are valid.

It is noted that the processing means of the registry will validate the information it receives from user terminals associated with its registered users and notarise the messages it receives such that the validity of the message is indicated to a recipient user. This indication of message validity may comprise a variety of components: for example, the registry may validate the identity of the sending user. It may further validate the contents of the message, whether the message has been transmitted without corruption (i.e. the integrity of the message) and it may also check the message against a set of system rules. It is also noted that the registry may also authenticate the message by signing with a digital certificate.

The present invention provides a number of advantages over a centralized title registry. The distributed nature of the present invention allows the system to be easily scalable. The lack of a central registry that is required to store all information relating to the users of the system also provides a more secure system and a system that is more resilient to unauthorized attempts to access the system, i.e. it is more resilient against hackers.

The distributed system according to the present invention is more adaptable and practical to deploy and quicker to adopt because several parties can create their own registries and connect them together to form a single distributed system.

The distributed system according to the present invention essentially comprises a number of distinct registry networks, each such registry network comprising a registry and the user terminal(s) of one or more of registered users who are associated with that registry.

In a first arrangement, all the messages that are sent or received are handled by at least one registry, i.e. all messages are routed through one or more registries. This enables each registry to validate the eligibility of a user terminal of a registered user to send/receive a message and also allows the registry to notarize the messages it sends or receives.

In an alternative arrangement, the user terminals of the registered users of the system may directly exchange messages in a peer-to-peer manner. In this arrangement the users may request that a registry validates and notarizes a particular message in the event that a trust relationship does not exist between the users exchanging the message in question.

The users comprise communication means for communicating with other registered users via a suitable data communications network, e.g. a local area network (LAN) or the Internet. The registries also comprise communication means for communicating with both their associated registered users and also other registries in the distributed system. The registered users may communicate with each other using a different data communications network to the registries. Alternatively, the registered users and registries may all be connected to the same data communications network.

In a further arrangement, a registry network may comprise more than one registry, the registries within the registry network in question being arranged into a hierarchical structure. For example, there may be one registry for each user terminal of a registered user within the registry network. However, only one of these registries may communicate with registries in other registry networks.

Preferably, each user is associated with only one of the registries within the system.

Each registry will conveniently be associated (e.g. via a local communications network or the Internet) with more than one user terminal. However, a registry may only be associated with a singe user terminal. The number of user terminals associated with different registries may not be the same in each case and different registries may therefore be associated with different numbers of user terminals (and therefore different numbers of user terminals).

In a variation of the above arrangement, a user terminal, for example a user terminal of a registered user who issues electronic documents onto the system, may be directly associated with a registry in such a manner that the user terminal effectively serves as a registry. In other words, the registry and the user terminal in question may be regarded as a single integrated unit on the system. Such an “integrated unit” user may additionally act as the registry for other users within the same registry network.

As a further variation to the above arrangement each user terminal may be directly associated with its own registry. Each registry and user terminal may in such an instance form single integrated units.

Conveniently, the messages that are exchanged across the system comprise a main contents portion which contains, for example, transaction details relating to a document stored on the system and a header portion that indicates the validity of the contents portion.

The contents portion is conveniently encrypted which allows a recipient to receive messages that they know are valid (because they have been validated and notarized by a registry) but without any direct access to the contents of the message without a decryption code (which may be provided by either the sending user or one of the registries). In arrangements where the messages relate to a transaction chain this allows the sender of a message to hide details of the previous endorsement chain whilst providing a guarantee to the recipient that the endorsement chain is valid.

Conveniently, the contents portion of the message is encrypted by the user terminal of the user who creates the message using a secret key. The user may generate the secret key used to encrypt the message.

Conveniently, the exchanged messages are validated and notarized by one of the registries. In this case, the header portion conveniently comprises an indication from the registry that the contents portion of the message is valid.

In order to ensure that users are eligible to use the distributed system, the registry and more particularly the processing means of the registry is arranged to assess the user terminal against a predetermined set of rules. Such a set of rules may for example comprise standard terms and conditions of use of the system.

Preferably, each registry stores a copy of a set of predetermined rules and all the registries within the distributed system use the same set or a compatible set of predetermined rules. This ensures that each registry can trust messages received from other registries as being valid.

Conveniently, each registry comprises a data store that is used to store electronic documents that are created and issued by users of the system. Each registry may store all the messages relating to an original electronic documents contained within its data store. These messages may then be stored within the data store and appended to the original electronic document. This allows changes and transactions relating to a document to be stored with the original document for ease of reference and transmission.

The registry may conveniently manage the access of users/user terminals to a particular stored document and its associated messages. For example, only the originating or issuing user/user terminal may be able to view the whole contents of the electronic document. Other users/user terminals may be restricted to partial access, e.g. access to the associated messages (or part thereof) only.

Conveniently, the registry is arranged to compile a message history such that all messages relating to a stored electronic document within the registry can be tracked over time.

Each registered user terminal and registry within the distributed system may comprise a data store. The original electronic document may then be stored at any convenient location on the system (e.g. in the data store of the user terminal of the user who issued the document or in the data store of the registry associated with that user terminal). Read-only copies of the original electronic document may be stored at other locations within the system to allow quick retrieval of the document. Preferably, the read-only copies of the electronic document contain a link (e.g. a hyperlink or a reference Uniform Resource Identifier) to the original version of the document.

The electronic document stored on the system may conveniently comprise an original contents portion that corresponds to the contents of the document at the time of creation or issue. This contents portion would comprise information input to the system by the registered user responsible for the creation of the document. The document may also conveniently comprise a message endorsement section which is arranged to record all the messages that are exchanged relating to that document. The access of registered users to a particular stored document and its associated messages may be determined by the record of all the messages relating to the document that have been exchanged between users of the system.

The distributed system may store multiple copies of an electronic document. The presence of multiple copies of a document within the system allows transactions and other actions only relating to a portion of the contents of a document to be effected on different copies of the document. This could be of benefit in cases where the electronic document relates to the title to a quantity of goods. The presence of multiple copies of the title document on the system would then allow transactions relating to part of the total quantity of goods to be made between different users of the system. Conveniently, the system registries monitor all exchanges between the user terminals of registered users of the system and prevent conflicting messages (i.e. transactions) occurring as a result of the multiple copies of the document.

In order to ensure that messages are encrypted correctly by user terminals and have not been inadvertently corrupted by the system each registry and user terminal may exchange a number of versions of the message in question. For example, the user terminal may send the message encrypted using the secret key as described above. Additionally, the user terminal may send the registry a version of the message in an unencrypted format and/or encrypted using another method, e.g. using a public/private key technique. This redundancy allows the registry to ensure that the message has been transmitted correctly, that the user/user terminal is authorized to send a message and that the message has not been corrupted in any way.

Once validated, the registry may conveniently notarize the version of the message that has been encrypted with the secret key for onward transmission to the recipient user's user terminal. If the recipient user wishes to read the encrypted message he may request the secret key from either the originating user/user terminal or alternatively the relevant registry.

As noted above, the registry and user terminal may conveniently exchange the message encrypted with a private/public key method. If the user encrypts the message with his private key then the registry can use the user's public key to decrypt the message. This has the advantage that it does not require the user to disclose their private key to anyone else within the system—even the registry.

The messages exchanged across the system between user terminals may additionally comprise digital certificates relating to the sending registered user and/or registry.

Conveniently, the distributed system described above may be used in a trading system wherein transactions relating to title documents, e.g. ownership documents, may be communicated between users of the system. The electronic title document may, for example, be a Bill of Lading.

According to a second aspect of the present invention, there is provided a method for communicating messages between registered users of a distributed system, each registered user communicating with the system via a user terminal, the messages relating to an original electronic document that is stored on the system and associated with one of the user terminals, and the system comprising a plurality of registries, each registry having a mutual trust relationship with each of the other registries and being associated with one or more user terminals, being connectable to a data communications network, the method comprising validating the eligibility of each of its registered users' user terminals to send or receive a message relating to the stored electronic document and notarising each message sent from or received by the user terminal of the registered user, the notarisation step indicating the validity of the message relating to the stored document.

It is noted that preferred features relating to the method of the second aspect of the present invention are described above in relation to the first aspect of the invention

According to a third aspect of the present invention, there is provided a distributed system for communicating messages between users of the system, each user communicating with the system via a user terminal, the system comprising means arranged to validate each message sent from or received by a user terminal, and to notarise each message sent from or received by a user terminal, the notarisation indicating the validity of the message, wherein each message comprises an encrypted message contents portion and a header portion, the header portion indicating the validity of the message contents portion to a recipient of the message.

It is noted that further preferred features relating to the system of the third aspect of the present invention are described above in relation to the first aspect of the invention.

Preferably, the system comprises a registry for receiving and sending messages between the user terminals, wherein the registry comprises a processing means arranged to validate each message sent from or received by a user terminal, and to notarise each message sent from or received by a user terminal, the notarisation indicating the validity of the message.

The messages that are exchanged between the registry and the user terminals of users of the system may conveniently be encrypted using a suitable encryption method, e.g. public/private key encryption, biometric encryption, embedded mutating data elements or validated timestamps.

The registry according to the third aspect of the present invention may further comprise communication means for communicating with further registries. Such further registries may be registries in accordance with the third aspect of the invention. In the event that the registry is in communication with further registries each registry has a mutual trust relationship with each of the other registries.

Where the registry receives messages from another registry for delivery to the user terminal of one of its users, the registry is arranged to further notarise the received message and send it to the intended recipient user's user terminal.

Each user terminal may further comprise means for requesting a decryption code for the encrypted contents portion of a message. Either the originating user terminal or their associated registry may provide the decryption code on request.

Preferably, the users are registered to the system and the system further comprises registration means requiring each user to register and log-in to the system before sending messages to other users.

According to a fourth aspect of the present invention, there is provided a method of communicating messages between registered users of a distributed system, each registered user communicating with the system via a user terminal, the system comprising at least one registry for receiving and sending messages between the user terminals, the method comprising validating each message sent from or received by a user terminal, validating each message sent from or received by a user terminal, the notarisation indicating the validity of the message wherein each message comprises an encrypted contents portion and a registry portion, the registry portion indicating the validity of the contents portion to a recipient of the message.

Preferably, the messages sent from or received by a user terminal comprise an encrypted contents portion.

It is noted that preferred features relating to the method of the fourth aspect of the present invention are described above in relation to the first, second and third aspects of the invention

According to a fifth aspect of the present invention, there is provided a registry for communicating messages between users of a distributed system, each user communicating with the system via a user terminal, the registry comprising communication means arranged to communicate with at least one user terminal; and processing means arranged to validate each message received by or sent from the at least one user terminal and to notarise each message received by or sent from that at least one user terminal, the notarisation indicating the validity of the received messages; wherein each message comprises a message contents portion and a registry portion, the registry portion indicating the validity of the message contents portion to a recipient of the message.

It is noted that preferred features relating to the registry of the fifth aspect of the present invention are described above in relation to the first four aspects of the invention.

The registry may also conveniently comprise a data store for storing original electronic documents and messages relating to the stored electronic documents.

The registry may comprise further communication means arranged to connect the registry to further registries, each registry having a mutual trust relationship with the each of the other registries.

According to a sixth aspect of the present invention, there is provided a method of operating a registry for communicating messages between users of a distributed system, each user communicating with the system via a user terminal, the method comprising: communicating with at least one user terminal; validating each message received by or sent from the at least one user terminal; notarising each message received by or sent from the at least one user terminal, the notarisation indicating the validity of the received messages wherein each message comprises a contents portion and a registry portion, the registry portion indicating the validity of the encrypted contents portion to a recipient of the message.

It is noted that preferred features relating to the method of the sixth aspect of the present invention are described above in relation to the first five aspects of the invention.

According to a seventh aspect of the present invention, there is provided a method of identity verification for allowing a first user of a distributed system to verify the identity of a second user of the system, each user of the system having a respective system identity, the distributed system providing a first communications path between the users, the method comprising: i) requesting the system to generate an authentication code; ii) providing the authentication code to at least one of the users; iii) exchanging the authentication code between users' system identities using the first communications path; iv) exchanging the authentication code between users using a second communications path that is independent of the system and the first communications path; v) comparing the authentication codes exchanged in steps (iii) and (iv) in order to verify the identity of the second user of the system.

According to a eighth aspect of the present invention, there is provided an electronic title document for use in a distributed system between multiple parties, the system comprising at least one registry having means for validating and notarising the electronic title document, the document comprising: a header section comprising information relating to the type of electronic document; a contents section comprising contents information; an issuer section comprising a digital signature relating to the document's originator; a registry section comprising a digital signature relating to the registry; and an endorsement section wherein changes relating to the document are recorded.

The changes relating to the document in the endorsement section may conveniently relate to changes in the ownership of the document. Alternatively, the changes could relate to other transactions relating to the document.

Preferably, the header and contents sections of the document are encrypted by both the issuer of the document and also the registry that is associated with that user.

The document may comprise further sections each of which is digitally signed by the originating user (i.e. the issuer) and also the associated registry.

According to a ninth aspect of the present invention, there is provided a method of issuing an electronic title document for use in a distributed system between multiple parties, the system comprising at least one registry having means for validating and notarising the electronic title document, the method comprising a document issuer populating a header field comprising information relating to the document type and populating a contents field comprising contents information relating to the document; digitally signing the header and contents fields by the document issuer; sending the digitally signed header and contents fields and digital signature from the document issuer to a registry; validating the information received from the document issuer; and digitally signing the information validated by the registry

It is noted that preferred features relating to the method of the ninth aspect of the present invention are described above in relation to the eighth aspect of the invention

The invention extends to an electronic transaction system comprising a distributed system for communicating messages according to the present invention and a system comprising a Bill of Lading as the electronic title document according to the first aspect of the invention.

The invention may also be expressed as a data carrier comprising a computer program to implement the methods of the present invention.

### BRIEF DESCRIPTION OF THE DRAWINGS

In order that the invention may be more readily understood, reference will now be made, by way of example, to the accompanying drawings in which:

FIG. 1 is a representation of a known trade system;

FIG. 2a is a simplified representation of a first arrangement for a distributed system according to an embodiment of the present invention;

FIG. 2b is a simplified representation of a second arrangement for a distributed system according to an embodiment of the present invention;

FIG. 2c is a simplified representation of a third arrangement for a distributed system according to an embodiment of the present invention;

FIG. 3 is a representation of an electronic document according to an embodiment of the present invention that can be used with the distributed system of FIG. 2a, 2b or 2c;

FIG. 4 is a flow chart showing the issuance of an electronic document in accordance with an embodiment of the present invention;

FIG. 5 is a representation of an addressing format that may be used to store the document of FIG. 3 in the system of FIG. 2;

FIG. 6 is a flow chart showing the communication of secure messages across the network of FIG. 2 in accordance with an embodiment of the present invention;

FIGS. 7a, 7b and 7c are representations of a partial endorsement process;

FIG. 8 is a flow chart showing the process of encrypting a message in accordance with an embodiment of the present invention;

FIG. 9 is a flow chart showing a first method of verifying the identity of user of a system according to an embodiment of the present invention;

FIG. 10 is a flow chart showing a second method of verifying the identity of user of a system according to an embodiment of the present invention; and

FIG. 11 is a flow chart showing a third method of verifying the identity of user of a system according to an embodiment of the present invention.

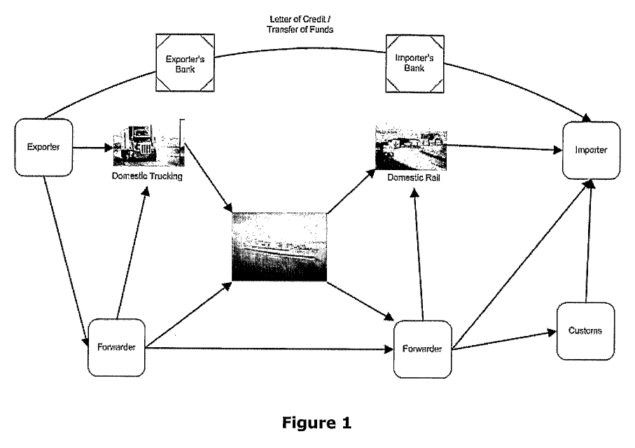

### DETAILED DESCRIPTION

A first example of a distributed system in accordance with an embodiment of the present invention comprises two or more registries which are arranged to send and receive messages from users of the overall system.

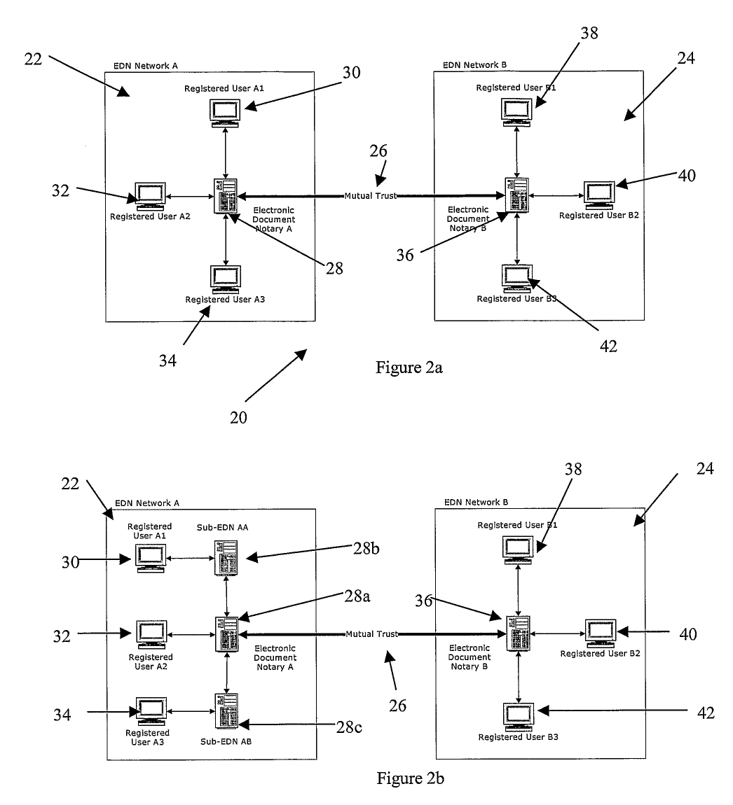

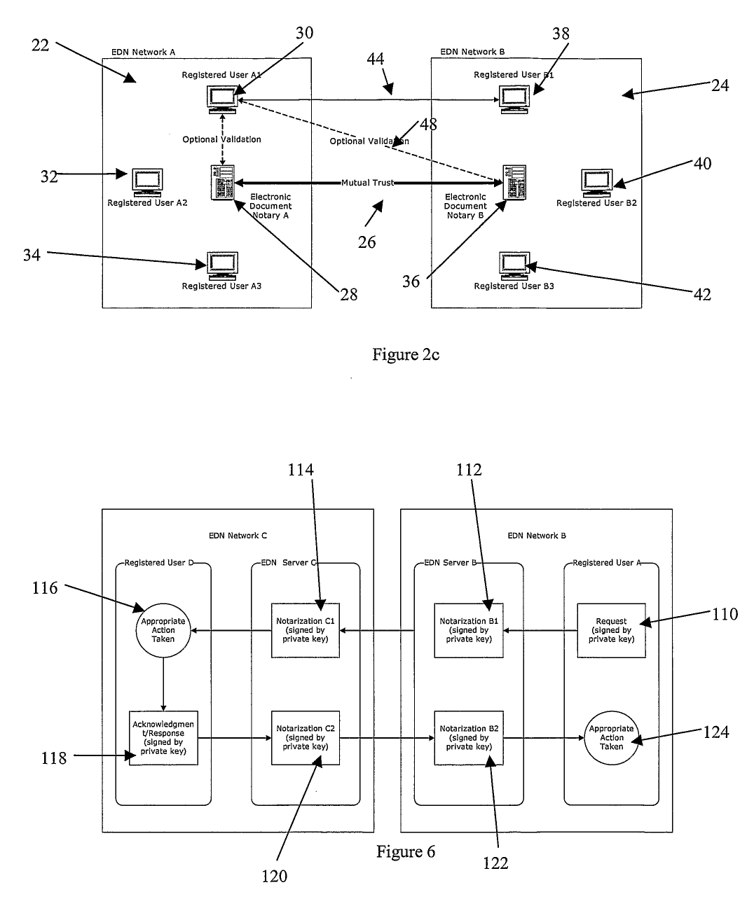

Such a distributed system 20 is shown in FIG. 2a. The system 20 comprises two networks, registry network 22 and registry network 24. It is noted that, for the sake of clarity, only two registry networks are depicted in FIG. 2a. However, it will be appreciated that the system 20 may comprise a plurality of registry networks.

Registry network 22 is in communication with network 24 via a suitable communications network 26, e.g. the Internet. The registries in the two networks 22 and 24 are known to one another such that there is a mutual trust relationship between the two.

Registry network 22 comprises a registry 28 having a data store, e.g. a server. The registry interfaces with the data communications network 26 and a number of registered users (30, 32, 34) of the network 22.

Registry network 24 comprises a registry 36 having a data store. Registry 36 is in communication with the data communications network 26 and a number of registered users (38, 40, 42) in a similar manner to that described in relation to network 22.

The registry networks create an extended network, the system 20, which enables messages to be sent and received between any of the users (30, 32, 34, 38, 40, 42) of the system 20.

It is noted that the relationship of mutual trust between the networks 22, 24 allows a registered user of the first network 22 to communicate with a registered user in the second network 24.

It is noted that users of each network are contractually bound by the same rules, regardless of the network that they are in, thereby ensuring a legally enforceable network chain.

In contrast to the prior art systems described above which utilise centralised title registries, the system according to the present invention uses a decentralized title registry. Such a decentralised system has major benefits over a centralized registry, such as adoptability, security, resiliency, scalability, and interoperability. The decentralized registry is built upon the concept of the registry networks 22, 24, which are trusted document authorities. Their servers and systems are responsible for notarizing the validity and ownership of title documents and related transactions. As noted above, a registry network comprises the registry (which is also referred to herein as an Electronic Document Notary or EDN) and its registered users. All parties in the EDN network are bound by a legal contract that equates digitally signed electronic transactions within the network to their real world equivalents.

The distributed system described above may be used to store electronic documentation and to exchange messages relating to that documentation. For example, the system (and more particularly the registry servers 28, 36) may store electronic versions of legal title documents. Messages exchanged across the system by users registered with one of the registry networks may transfer ownership of the electronic documentation or record rights that the users have to such documentation.

A further example of a distributed system in accordance with an embodiment of the present invention is shown in FIG. 2b. It is noted that like numerals have been used to denote like features.

In FIG. 2b, registry network 22 comprises more than one registry (28a, 28b, 28c). As depicted in FIG. 2b, there is a registry for each registered user (user 30 is associated with registry 28b, user 32 is associated with registry 28a and user 34 is associated with registry 28c).

The registries (28a, 28b, 28c) form a hierarchical structure in which registry 28a is the primary registry. The primary registry, in this case registry 28a, communicates with registries in other registry networks and as shown in FIG. 2b, registry 28a has a mutual trust relationship with registry 36 in registry network 24.

The arrangement shown in FIG. 2b allows better scalability and faster adoption of the distributed system. It is noted that the each user is directly associated with one registry in the registry network 22. In a further variation of the system the user and its associated registry may form a single integrated unit.

A still further example of a distributed system in accordance with an embodiment of the present invention is shown in FIG. 2c. Once again like numerals have been used to denote like features with FIGS. 2a and 2b.

The arrangement of FIG. 2c is virtually identical to the distributed system shown in FIG. 2a. In this case, however, registered users of the system can communicate directly with one another in the manner of a peer-to-peer system.

In this example, the peer-to-peer message exchanges are built upon a network of trust between the various users of the system. The registries (28, 36) enable messages and transactions to be validated and notarised in the event that two particular users do not have an established trust relationship.

For example, user 38 (in registry network 24) may send a message to user 30 (in registry network 22). If a trust relationship does not already exist between these two users then user 30 may request that registry 28 validates that a trust relationship exists between registry 30 and the registry associated with user 38, i.e. registry 36, and that further a trust relationship exists between registry 36 and user 38.

The request from user 30 establishes a trust relationship between user 30 and user 38. Additionally, a trust relationship is also established between user 30 and registry 36. The establishment of the trust relationship means that next time users 30 and 38 communicate with one another it will be unnecessary to repeat the validation process.

Furthermore, since additionally a trust relationship has been established between user 30 and registry 36, any future communications from the other users of registry network 24, i.e. from users 40 and 42, will only require validation and notarisation from registry 36 and will not necessarily need to involve registry 28.

In a peer-to-peer arrangement, as shown in FIG. 2c, read-only copies of an original electronic document may be stored at any node (i.e. at any registry or user) within the network to facilitate quick retrieval of the document. All such read-only copies may be arranged to contain a reference (e.g. a hyperlink) to the original version of the electronic document. In order to avoid conflicting messages and/or transactions occurring, only the original version of the electronic document can be used to effect transactions.

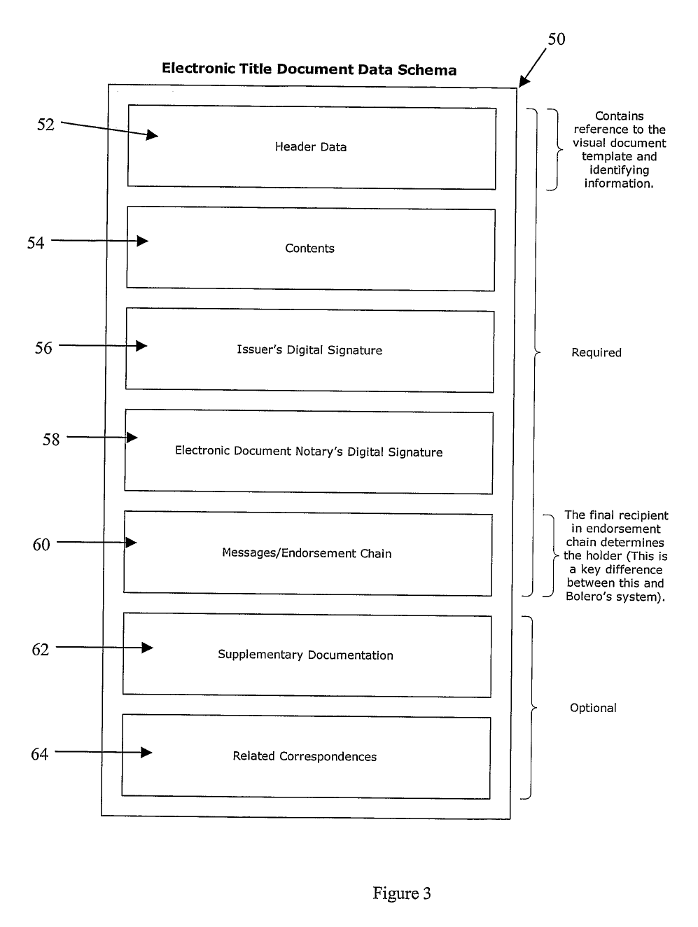

As described below in relation to FIG. 3, all transactions and endorsements relating to an electronic document are appended to the original electronic document. The original electronic document may be stored at any convenient place within the system.

For example, it can be stored in a data store associated with the registered user who issued the electronic document. As an alternative, each registry may comprise a data store which stores original electronic documents associated with its registered users.

It is noted that the following description generally refers back to the arrangement shown in FIG. 2a. It will be appreciated by the skilled reader, however, that the following embodiments apply equally to the arrangements shown in FIGS. 2b and 2c.

An example of an electronic title document that is stored within the data store of one of the registries is shown in FIG. 3. The document 50 comprises a number of sections (52, 54, 56, 58, 60, 62, 64), each of which is appropriately encrypted and signed using a Public-Key Infrastructure (PKI).

Section 52 is a Header portion which essentially comprises bibliographic information relating to the document to be stored on the distributed system 20. For example, Header 52 may comprise information relating to the type of title document that is being stored on the system, the particular registry network that is storing the document and authorising messages and transactions relating to it, a document identification number (e.g. a document number), the issuer of the document and details of any other referenced documentation.

Section 54 relates to the specific content of the legal document to be stored on the system 20. This portion therefore comprises all the data that would traditionally have been included on a paper based version of the title document.

In order to provide a secure system 20, each registered user has a user-specific digital signature that is used to sign documents and messages. Section 56 of the document 50 comprises this digital signature.

In order to attest the legal validity of a document the electronic document notary (i.e. the registry) encrypts and signs information received from users of that notary's network. Section 58 of the document therefore comprises the registry digital signature.

An electronic document once created is preferably stored on the registry at which it was created (alternatively the document could be stored with the issuing user). In order to allow transfer of ownership, endorsements of the document contents and recording of other messages relating to the document contents, the electronic document 50 comprises a message/endorsement section 60 which stores details of all the transactions and messages relating to the document 50. This endorsement chain allows the final recipient of the document 50 to determine the holder.

The document may also comprise a number of other sections. For example, a supplementary documentation section 62 may store supplementary documents that are associated with a document of title. It is noted that all such documentation in this section 62 requires digital signature by the originator of the document and also the registry.

A related correspondence section 64 may also be provided that stores notable correspondence regarding the document of title. Such correspondence requires signature by the sender, recipient and relevant registries in order to maintain the security of the system.

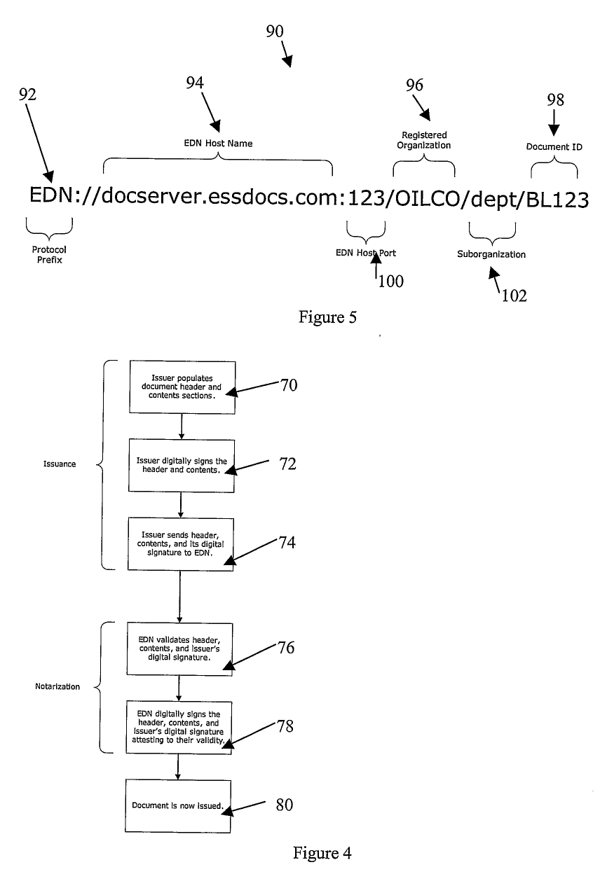

FIG. 4 is a flow chart showing the process of creating, issuing and notarising an electronic document 50.

In Step 70, a registered user populates the header 52 and contents 54 sections of the electronic document 50.

In Step 72, the information in the sections 52 and 54 is digitally signed using the user's digital signature as stored in section 56 of the document 50. It is noted that the user additionally encrypts the header and contents information prior to signing.

In Step 74, the user sends the encrypted and signed header 52 and contents 54 section information to the user's registry. The user's digital signature is also sent to the registry.

In Step 76, the registry validates the header and contents information received from the user along with the user's digital signature.

Having validated the information it has received, the registry, in Step 78, encrypts and signs the header section 52, contents section 54 and user's digital signature 56 using its own digital signature 58. This process enables the registry to attest to the legal validity of the information it has received.

Once Step 78 has been completed, the document is issued (Step 80). It is noted that once a document 50 has issued none of the information in the first four sections (52, 54, 56 or 58) of the document can be altered. The only subsequent changes that are allowed are amendments or verified encryptions that are stored in the message chain section 60 (or the optional sections 62 and 64).

Once the document 50 has been issued it is stored in the data store of the registry.

Documents 50 stored on the system 20 may be stored in any of the plurality of registries within the distributed system 20. In order to enable easy location and retrieval of documents, the system may store documents 50 according to a specialised Uniform Resource Identifier (URI). A typical document URI 90 is shown in FIG. 5. The URI 90 comprises a suitable prefix 92, e.g. EDN for Electronic Document Notary, a section 94 detailing the particular EDN that is hosting the document 50, a section 96 that details a registered user code and a section 98 that details a document identifier number or code.

Optionally the URI 90 comprises a host port identifier 100 for the hosting EDN and a section detailing further organisational information 102.

As an alternative, the system 20 may store documents 50 upon a scheme based on Globally Unique Identifiers (GUIDs).

Transactions relating to documents 50 held on the system 20 are made by means of messages exchanged between registered users of the system 20 and the registries (electronic document notaries). In order that messages across the distributed system 20 are secure each user and registry notarises each message sent using the Public-Key Infrastructure.

FIG. 6 is a flow chart showing the process of sending a transaction message from user A to user D. It is noted that registered user A and registry B (as denoted by EDN Server B in FIG. 6) are part of registry network B. It is further noted that registered user D and registry C (as denoted by EDN Server C in FIG. 6) are part of registry network C.

Registry networks B and C are part of a distributed system 20. A mutual trust and legal relationship between the two registries has been established such that users registered to each of the registries operate under a common legal frarnework,

In Step 110, user A creates a transaction message for user D which it signs with its private key. This signed message is then sent to user A's registry, registry B.

In Step 112, registry B validates the claims made by user A to the title of documents referred to in the message. The message received from user A is then notarised by registry B by further digitally signing the message with the digital signature of registry B. Registry B then forwards, via the data communications network linking networks B and C, the now notarised message to Registry C.

In Step 114, registry C validates that user D is an eligible recipient of the message and will fulfil the legal requirements of the transaction should the transaction be executed. Assuming these conditions are satisfied, Registry C notarises the message by further digitally signing it with its own private key. The message is then passed to user D.

In Step 116, user D takes the actions appropriate to the message received from user A. An acknowledgement message or alternatively a response transaction message is then created and digitally signed with user D's private key in Step 18 and sent to Registry B.

The acknowledgement message is then checked and notarised by Registries C and B (in, respectively, Steps 120 and 122) in a manner analogous to steps 110 to 116. Once the acknowledgement message is received, user A takes appropriate action (step 124).

It is noted that without the verifiable notarisation mechanism described above the registry servers will not carry out the required transactions relating to the documents of title.

Digitally signing is defined as authorizing the message by:
a) Using a hashing algorithm to generate a message hash digest
b) Encrypting the hash digest with the private key
c) Attaching a digital envelope containing the encrypted hash digest and digital certificate to the message

The action of signing the message protects the integrity and non-repudiation of the message. A recipient can verify that the user who had signed the message had indeed seen the message and authorized those exact contents of the message by:
1. Verifying the identity of the signatory by verifying the digital certificate.
2. Decrypting the encrypted hash digest using the signatory's public key included in the digital certificate.
3. Running the hash algorithm on the contents and comparing the hash digest with the decrypted hash digest.

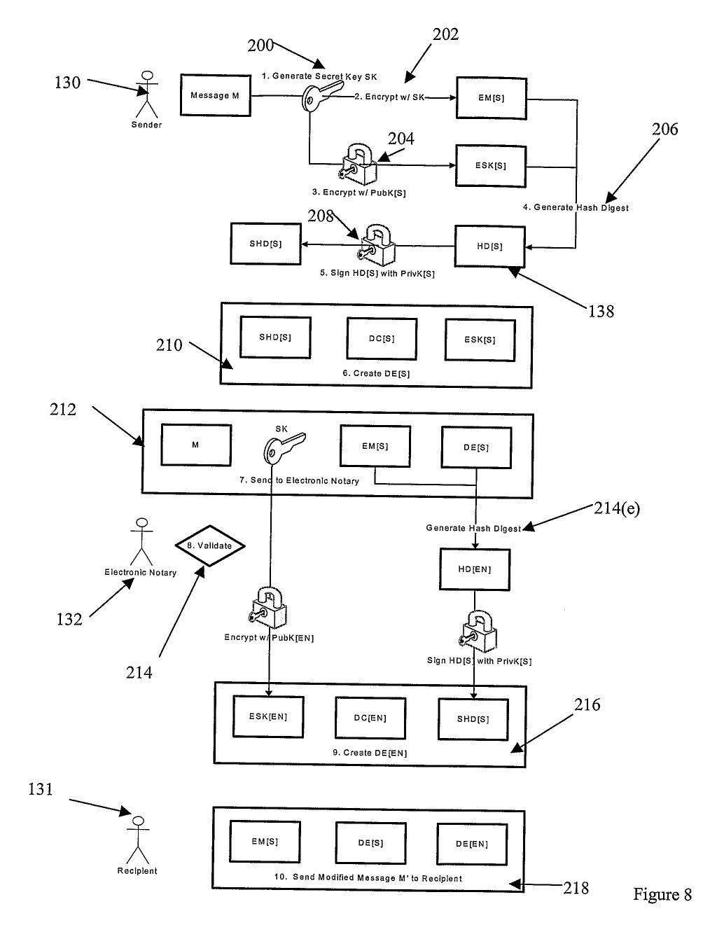

The method of sending encrypted messages is described in more detail below with reference to FIG. 8.

An electronic title document of the type described above in relation to FIGS. 2 to 5 is conveniently defined by means of a template that comprises all the information required to enable the distributed system to operate, e.g. binding terms and conditions, a data schema, and the relationship between the two regarding the visual placement and rendering of data on the template. The relationship enables the visual rendering of the electronic documents that are equivalent to existing paper documents. This visual rendering may be used as the basis for legal enforceability as well as giving users accustomed to paper-based processes a sense of comfort.

An electronic title document of the type described above is an aggregation of the relevant streams of data generated by the multiple users of the distributed system. When combined with the system's legal framework and the referenced or included document template's terms and conditions, it has the same legal effect as that of the equivalent physical document of title such as a paper Bill of Lading.

The concept of a document is in contrast to prior art systems in which electronic documents are represented as specialized modifiable database records.

As an alternative, the electronic document may be represented by any of the following transmittable representations: XML, XML Encryption, XML Signatures, or the Portable Document Format (PDF).

An example of an embodiment of an electronic document in XML format is:

<?xml version=“1.0” encoding=“UTF-8”?>
< ESSDoc xmlns=“http://www.essdocs.com/schema” GUID=“...”
ESSTemplate=“...”>

<Contents>

<DocumentData>

...

</DocumentData>
<IssuersSignature>...</IssuersSignature>
<Notarization>...<Notarization>
<Endorsement>...</Endorsement>
<Notarization>...</Notarization>
<Endorsement>...</Endorsement>
<Notarization>...</Notarization>
...

</Contents>
<Notarization>...</Notarization>

</ESSDoc>

The distributed system and electronic document of the present invention provide a system in which all of the information relevant to a document is stored together instead of in separate data tables. This representation is also inherently more secure and tamper resistant because of its extensive use of Public-Key Infrastructure. This document representation has been designed to operate in a distributed environment where documents may fall into the hands of untrustworthy parties.

Transactions may be performed on an electronic title document according to an embodiment of the present invention. As described above in relation to FIG. 6 all messages relating to an electronic document stored on the system are managed such that only duly authorized parties can view or perform transactions on documents. All transactions performed on an electronic title document are notarized by the associated registry and logged.

For the sake of illustration, several users of the distributed system of the present invention are described in the context of a Bill of Lading are described. The users are:
1. Shipper—The party who initially owns and ships the goods.
2. Consignee—The party who bought the goods. This may or may not be explicitly declared.
3. Notify Party—A party who is to be notified at the arrival of the goods.
4. Carrier—The vessel owner who transports the goods and issues bills of lading.
5. Holder—The current owner of a Bill of Lading.

Prior to issuing a document in accordance with the process described in relation to FIG. 4, a back-and-forth process of drafting and revising the information within a document may occur between several users. The system enables collaborative drafting, a process by which only entitled users are able to access the document in draft and change the contents of the document. All changes are logged.

Only entitled registered users of a registry, such as shipowners or their agents in the above example, are allowed to issue a document. Issuance is the process by which a valid document of title is created. The issuance process is depicted in FIG. 4.

A valid issued document should contain the first four sections of electronic title document as previously described. Upon issuance, the issuing user, as well as the registry, digitally signs the electronic title document. None of the information in the first four sections of the document can be changed after the initial issuance. Subsequent changes to the document are by way of amendments and verified encryptions as described below. The digital signatures stored in the designated sections of the document can be used to ensure the integrity and authenticity of the issued document in a distributed environment.

After a document has been issued, it may be negotiated using the method described in relation to FIG. 6. This is the process by which the title of the document is transferred. A major improvement in this system over previous centralized title registry systems is the process by which the dominion of an electronic document of title is determined and transferred. Prior centralized title registries determined ownership by retrieving the named owner in a special field of a database. In a distributed system, using such an easily modifiable field to determine ownership poses major security concerns. Allowing external parties to modify previously generated data is highly insecure in a distributed environment that may include interaction with unknown parties. The solution to this problem is to allow only two kinds of modifications to issued documents after the initial issuance:
1. Appending new data
2. Verified encryption of existing data

This concept is heavily utilized in the endorsement process of the distributed registry system. The distributed registry system of the present invention uses a PKI-based endorsement chain to determine ownership of the document of title. Endorsements (transfer of title) of an electronic document are appended as appropriately signed endorsement messages (as described in relation to FIG. 3) instead of modifying a holder field in a database record. Ownership is determined by traversing the endorsement chain and identifying the final valid recipient.

To endorse an electronic title document, a publicly viewable digitally signed message that represents the endorsement of the document title is appended to the document.

In order to prevent a recipient user from viewing the identity of the user from whom the document is obtained, the distributed registry system encrypts the previous endorsement prior to endorsing the document. This process hides the encryption chain from future holders of the electronic document.

A number of transactions which are common to the Bill of Lading/shipping environment are discussed briefly below in the context of the present invention.

Production

A production is simply an endorsement by the final holder of the document back to the issuer, for instance, the carrier in a Bill of Lading process. This represents the surrender of the title document in exchange for the goods being delivered to the final holder, and thus the accomplishment of the voyage.

Amendment Request

Another prevalent transaction is an amendment request. This is the process by which the current holder of the bill can request that modifications are made to the original issued bill and that revised bills be issued replacing the original bill. Such amendments in the case of a Bill of Lading, for instance, include splitting, merging, changing the delivery port, or other document detail. After the amendment is requested, the original document is endorsed back to the issuer or “surrendered.” The issuer then makes the requested amendments and issues a new document with reference to the surrender document. An added advantage of the electronic system over the current paper-based processes of is that the document can be reissued directly to the order of the party who requested the document change (presuming the legal framework supports such a process).

Transfer to Paper and Back

Another very important innovation in this system over prior systems is the process by which an electronic title document can be transferred to a paper equivalent and then back into an electronic form. At the time of transfer, the electronic document is marked void and is no longer negotiable. At a later time, the paper documents can be deemed void and the electronic document reactivated. The paper bill would be referenced in the reissued electronic bill. This allows the electronic system to seamlessly interact with paper-based processed.

Legal Framework

The invention is supported by a legal framework consisting of two documents: the terms and conditions; and, the operating policy and procedure. This framework ensures that the electronic documents create the same legal rights and obligations, incorporate the same treaties and are used in the same way as a signed paper version equivalent.

Under the framework, electronic issuance, negotiation and production are undertaken when a holder of the draft or original bill, as appropriate: authenticate themselves to the system; provide the requisite system instructions to transfer the document (title); and, digitally sign or endorse the document. The change to a document and/or the transfer of any documents is recorded in an appropriate audit log.

In effect, the invention replaces physical transfer of a paper document with the transfer of access to the original trade data; all without affecting the functionality of the document or other trade processes.

The present invention provides a number of advantages over a centralized title registry. The distributed nature of the present invention allows the system to be easily scalable. The lack of a central registry that is required to store all information relating to the users of the system also provides a more secure system and a system that is more resilient to unauthorized attempts to access the system, i.e. it is more resilient against hackers.

The distributed system according to the present invention is more adaptable and practical to deploy and quicker to adopt because several parties can create their own registries and connect them together to form a single distributed system.

By contrast, a centralized registry requires one party arduously trying to register everyone. Multiple registry servers also make the network more scalable since the network does not rely on a single server, which could easily become a bottleneck. The distributed environment is also more resilient because it does not have a single point of failure. If a single registry is deactivated, the rest of the distributed system remains operational.

It is also noted that the document and transaction (message) model according to the present invention heavily utilizes public key infrastructure to protect documents from forgery or fraudulent transactions. Several example of the increased security are provided below:
The document issuer needs protection against forgery and requires the exclusive ability to issue documents on his behalf. This is ensured by digitally signing the document with the issuer's private key upon issuance.
A recipient of a document needs to be assured that the document was indeed issued by the issuer. This can be done by verifying the issuer's digital signature. Furthermore, the registry notarises the issuance by digitally signing the issued document. This provides two levels of guarantees as to the authenticity and validity of the document.
An endorsee of a document might want to hide the previous endorsement chain; however a recipient would want to be guaranteed that the endorsement chain was valid and the endorsee was indeed the document holder. This can be ensured by using the Encrypted Message Notarisation process described below.
A recipient needs protection against the previous holder of a document negotiating the document again to another party. The registry tracks the ownership of the bills issued under its authority and notarises only endorsements of documents by their proper holders.
An electronic document notary needs to be aware of all transactions occurring within its network. Therefore an EDN must digitally sign every transaction occurring within its network in order for the transaction to be valid and further processed.
An electronic document notary must also be guaranteed that transactions from remote users in a remote registry network are valid. To ensure this, the system requires the remote registry to digitally sign all messages transmitted from within its network to attest to their validity.

Variations of the present invention may include variations of the document concept, the electronic document notary (registry) concept, and the means by which transactions are notarized.

The document may be modified to exclude the visual form template or be substituted with other digital instruments. The visual form template or its substitute may not include additional terms and conditions.

The involvement of the electronic document notary may be modified as discussed in relation to FIGS. 2b and 2c.

Other mechanisms for notarization could be substituted for Public-Key Infrastructure. These mechanisms could include, but are not limited to, biometrics, embedded mutating data elements, or validated timestamps.

FIGS. 3 and 6 above describe how an electronic document can be negotiated and endorsed once it has been issued. As described above there is a single instance of the electronic document on the system and all endorsements are entered into the endorsement section 60 of the electronic document.

A variation to the negotiation process is the concept of partial endorsement. In current paper based systems it is not uncommon for multiple copies of documents, relating for example to a quantity of goods, to be issued. This then allows a holder to take a first copy of the document and endorse a fraction of the total quantity of goods to a first person. Further fractions of the total quantity can then be endorsed using further copies of the document to other persons. In this manner, a holder can partially endorse the entire original quantity of goods and have each part be independently negotiable.

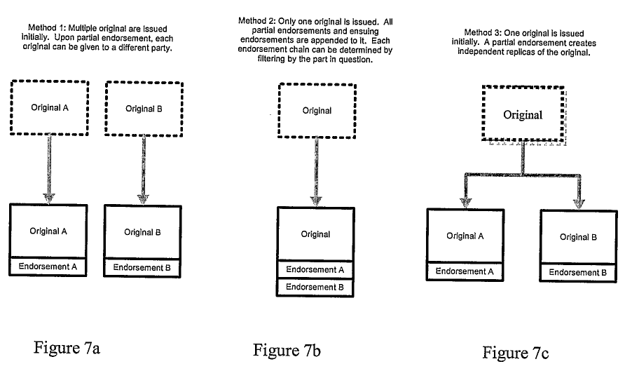

The distributed system and electronic document format described above allow a similar process to take place in the electronic environment of the invention. Three general modes of partial endorsement are possible and these are depicted in FIGS. 7a, 7b and 7c.

FIG. 7a shows a first method of partial endorsement in which multiple copies of an electronic title document are issued. Each of the original documents relates to different parts of the goods covered by the title document. Each original can therefore be endorsed in respect of the part of the goods to which it relates. The use of the validating and notarising system of FIGS. 2a-2c tracks the various endorsements made to the original documents to ensure there are no conflicting transactions.

FIG. 7b shows a second method of partial endorsement in which only a single original electronic document is issued. All partial endorsements relating to this original document are appended to the electronic document in the manner described in relation to FIG. 3. The endorsements are once again validated and notarised by a registry within the system and the registry is capable of filtering the endorsement chain such that only endorsements relating to a particular part of the total quantity of goods can be viewed at one time.

FIG. 7c shows a third method of partial endorsement. In this method a single original electronic document is issued. In the event that a partial endorsement is made the original document is replicated to form multiple copies of the electronic document. Each replica has its own endorsement chain.

As described above, the distributed system according to an embodiment of the present invention uses a mutually trusted third party, a registry or Electronic Document Notary (EDN), to guarantee the validity of messages exchanged between users of the system. FIG. 8 is a flow chart which illustrates the process of message generation, encryption and exchange in accordance with a further embodiment of the present invention.

Turning to FIG. 8, a user 130 of a distributed system 20 wishes to send a message (M) to another user 131 of the system 20.

In Step 200, the user 130, or sender (S), generates a secret key (SK).

In Step 202, the user 130 encrypts the message (M) with the secret key (S) to form an encrypted message, (EM[S]).

In Step 204, the user 130 uses his public key (PubK[S]) to encrypt the secret key (SK) to create an encrypted secret key (ESK[S]). It is noted that the secret key is inaccessible without possession of the user's 130 private key (Priv[S]).

In Step 206, the user 130 generates a hash digest (HD[S]) from the encrypted message (EM[S]) and encrypted secret key (ESK[S]).

In Step 208, the hash digest (HD[S]) from Step 206 is signed using the user's 130 private key to form a signed hash digest, (SHD[S]).

The user 130 then, in Step 210, creates a digital envelope (DE[S]) comprising: (i) the encrypted secret key (ESK[S]) from Step 204, (ii) the signed hash digest (SHD[S]) from Step 208, and (iii) the user's 130 digital certificate (DC[S]).

Following Step 210, the user 130 is now ready to send details of his message [M] to the Registry 132, referred to here as the Electronic Notary [EN], for further notarisation before onward transmission to the recipient user 131.

In Step 212, therefore, the user 130 sends the following information to the electronic notary [EN]:
(i) the user's 130 secret key (SK)
(ii) the message [M] that the user wishes to send
(iii) the encrypted message (EM[S]) from Step 202, and
(iv) the digital envelope (DE[S]) created in Step 210.

The electronic notary 132 receives the information sent from the user 130 and then, in Step 214, performs the actions (a) to (g) in Step 214 to verify the validity of the information received from the user 130:
a) The digital certificate (DC[S]) of the user 130 is validated to verify the identity of the sender (S).
b) The contents of the message (M) are verified as valid according to the rules previously agreed to by the user 130, user 131, and the electronic notary 132 (EN).
c) The electronic notary 132 encrypts the message (M) with the secret key (SK) of user 130 in order to generate a newly encrypted message (EM[EN]).
d) The electronic notary 132 then verifies that (EM[EN]) is identical to the original encrypted message (EM[S]), thereby ensuring that the original encrypted message (EM[S]) was not improperly encrypted or corrupted.
e) The notary 132 then generates a hash digest (HD[EN]) of the newly encrypted message (EM[EN]) and the sender encrypted secret key (ESI([S]) by using the same hashing algorithm used by the sender (S).
f) The notary 132 uses the public key, (PubI([S]), of the user 130 to decrypt the signed hash digest (SHD[S]) contained within the digital envelope (DE[S]). This decryption step (f) results in a recovered hash digest (HD[S]′).
g) The notary 132 then verifies that the hash digest (HD[EN]) generated in step (e) is identical to the recovered hash digest (HD[S]′) from step (f), thereby ensuring the integrity of the encrypted message (EM[S]).

In Step 216, assuming the message [M] is validated according to Step 214, the electronic notary (EN) then performs actions 216(a) to 216 (d) in order to electronically notarize the encrypted message (EM[S]) and attest to its validity:
a) The secret key (SK) of the user is encrypted using the electronic notary's (EN) public key (PubK[EN]), to generate an encrypted secret key (ESK[EN]). This action renders the encrypted secret key (ESK[EN]) inaccessible without possession of the electronic notary's (EN) private key (PrivK[EN]). This serves as a backup should the encrypted secret key (ESK[S]) of the user 130 be corrupted.
b) The notary 132 then hashes the user 130 encrypted message (EM[S]) and the digital envelope (DE[S]) of the user 130 in order to generate a hash digest (HD[EN]).
c) The hash digest (HD[EN]) from step 216(b) is then signed with the electronic notary's 132 private key (PrivK[EN]) to generate a signed hash digest (SHD[EN])
d) A digital envelope (DE[EN]) is then created by the notary 132 that includes the following:
   (i) The encrypted secret key (ESK[EN]) from Step 216(a).
   (ii) The signed hash digest (SHD[EN]) from Step 216(c).
   (iii) The electronic notary's 132 digital certificate (DC[EN]).

In Step 218, a modified message (M′) is sent to user 131. The modified message (M′) includes:
(i) the encrypted message (EM[S])
(ii) the digital envelope (DE[S]) of user 130
(iii) the digital envelope (DE[EN]) of the electronic notary 132

The user 131 cannot view the original contents of the message (M) without permission from either the sending user 130 or the Registry/electronic notary 132.

Receiving user 131 can request permission to view the message (M) by sending the encrypted secret key (ESK[S] or ESI([EN]) from the respective digital envelope (DE[S] or DE[EN]) to the respective party (user 130 or electronic notary 132).

If the user 130 or electronic notary 132 wants to grant the recipient user 131 permission to view the message (M), it recovers the secret key (SK′) by decrypting the encrypted secret key (ESK[S] or ESK[EN]) by using its private key (PrivK[S] or PrivK[EN]).

The party (user 130 or electronic notary 132) then sends the recovered secret key (SK′) to the recipient user 131.

User 131 can then decrypt the encrypted message (EM) using the recovered secret key (SK′).

The process described above in relation to FIG. 8 allows a message (M) to be securely transmitted from a first user 130 to a second user 131 via a modified message packet (M′). The encrypted message contents (EM[S]) are inaccessible to the second user 131 without permission from the either the first user 130 or the electronic notary 132. The presence of the digital envelope of the electronic notary 132, however, guarantees the message (M) to be valid.

In addition, the message (M) can be recovered by the second user 131 without the first user 130 or the electronic notary 132 having to disclose their private keys (PrivK[S] or PrivK[EN]).

Variations of the above described encrypted message process are possible. For example the electronic notary 132 may be trusted with the private key, PrivK[S], of the user 130. In such a case, the electronic notary 132 would perform the relevant steps on behalf of the user 130. The sender's digital envelope (DE[S]) could also be removed in such a case.

An important factor in any secure system is the ability to identify the identity of users of the system and to verify that users are who they claim to be.

A further embodiment of the present invention provides a method for users to match other user's of a system with the user identification assigned by the system to that other user.

Specifically, the further embodiment allows a first user A to confirm that user B is appropriately identified as user B within the system environment.

The method of identity verification utilizes a secondary communications medium, separate to the system environment, to verify a user's identity. Person A may then transmit or receive information, e.g. data or a question, through the secondary communications path to/from Person B. The information may be randomly generated, generated via an algorithm or may be personally generated. The secondary communications path may comprise a telephone network, a secure email service or any other communications path that ensures Person B is the only transmitter/recipient of the information to/from Person A.

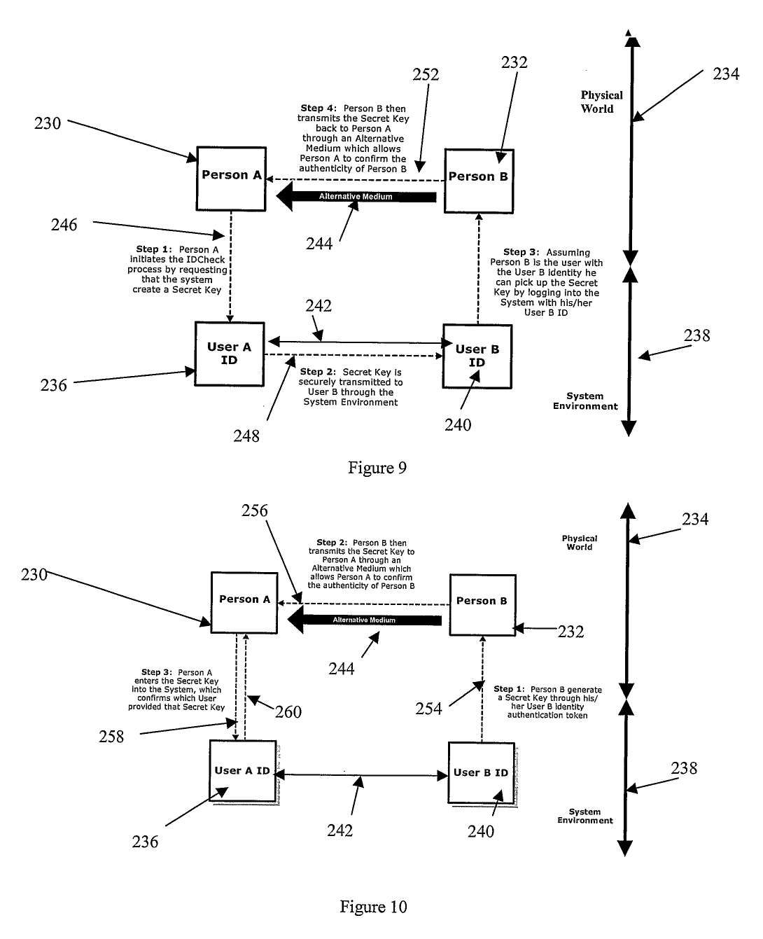

FIGS. 9, 10 and 11 describe three aspects of the method of identity verification in accordance with the further embodiment of the present invention.

Turning to FIG. 9, Person A (box 230) and Person B (box 232) are shown in the physical world 234.

Person A is assigned a user identification User A ID (box 236) by a distributed communications system 238. Person B is assigned user identification User B ID (box 240) by the system 238.

A first communications path 242 exists within the system 238 environment between the identification profiles, user A ID and user B ID, of the two users, Person A and Person B. A secondary communications path 244 exists between Person A and Person B in the physical world 234.

Referring back to FIG. 9, the identity verification is performed in accordance with the following steps:

In Step 246, Person A via their system ID, User A, initiates the identity verification process in accordance with the further embodiment of the present invention in order to match Person B with the system ID “User B”. The process is initiated by Person A requesting the System 238 to create a random piece of information (a “Secret Key”). The Secret Key can be alphabetical, numeric, alpha numeric, or simply a piece of information.

In Step 248, the system 238 both displays the secret key to User A and also securely sends it through the system to user B (via the first communications path 242).

In Step 250, Person B logs onto the system 238 with their User ID and downloads the Secret Key.

In Step 252, Person B sends the Secret Key as received by the user ID, User B, to Person A using the second communications path 244. This second communications path allows Person A to recognize Person B through a secondary source, e.g. by recognizing his voice over a telephone, then repeats the Secret Key back to Person A. Person A then confirms that the Secret Key received from Person B matches the Secret Key received in Step 248 from the system 238—if the key matches, then User A has matched Person B with the User B identity.

FIG. 10 shows an alternative method of identity verification using the second communications path 244. In this case, Person B requests the system 238 to generate a Secret Key (or authentication token) (Step 254).

In Step 256, Person B sends the authentication token to Person A via the second communications path 244.

In Step 258, Person A (as User A) enters the authentication token into the system 238 which confirms (Step 260) that the token originated from User B.

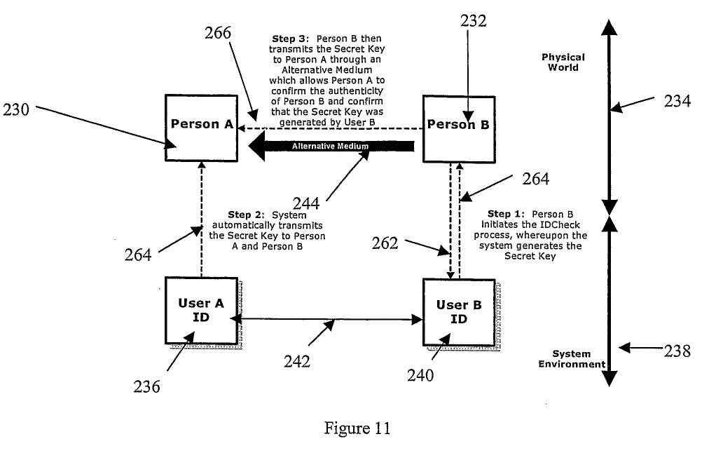

FIG. 11 shows a further alternative method of identity verification in which Person B, at the request of Person A, requests the system 238 to generate a Secret Key (step 262). This Secret Key is sent by the system 238 to both User A and User B such that it can be picked up by both Person A and Person B (Step 264). In Step 266, Person B transmits the Secret Key to Person A via the second communications path 244 such that Person A can compare the Secret Key against the version they downloaded from the system 238.

The method of identity verification described above offers significant advantages over traditional methods of issuing system identities, protecting against identity theft and protecting against fraudulent registration of identities.

The method is an improvement on traditional authentication and due diligence mechanisms because it allows user A to undertake a user-to-user matching of User B's system identify with the actual Person B in the real world.

The method further provides a user of a system with the ability to reconfirm and match the actual identify with the program/user identity of a person, company or entity. Therefore individual users are no longer required to rely purely on the due diligence of the System Entity.

In addition, the method may also reduce fraud because its use within a System Environment deters potential malicious users from applying for an account or user ID for the system due to the likelihood of being caught by other users.

Lastly, it is noted that the method of identity verification described above places the due diligence matching in the hands of the users, who may well be better placed to match an actual user to his/her system ID that the System Entity due to a long and ongoing trade or other relationship with that user.

The method may be implemented by for example passing information, either a number, word, phrase, noise or alpha-numeric code to an individual over for instance a telephone, fax, or face-to-face interaction.

It will be understood that the embodiments described above are given by way of example only and are not intended to limit the invention, the spirit and scope of which is defined in the appended claims. It will also be understood that the embodiments described may be used individually or in combination.

We claim:

1. A distributed system for communicating messages between registered users of the system, each registered user communicating with the system via a user terminal, the messages relating to an original electronic document that is stored on the system and associated with one of the user terminals, the system comprising:
a plurality or registries, each registry having a mutual trust relationship with each of the other registries and each registry being associated with one or more user terminals; wherein each registry is connectable to a data communications network, and comprises a processing means arranged to validate the eligibility of each of its registered users' user terminals to send or receive a message relating to the stored electronic document, the processing means further being arranged to notarize a message sent from or received by the user terminal of one of its one or more registered users, the notarization indicating the validity of the message relating to the stored document.

2. A distributed system as claimed in claim 1, wherein the system comprises a plurality of registry networks, each network comprising a registry and one or more user terminals associated with the registry.

3. A distributed system as claimed in claim 2, wherein the system is arranged such that messages between users are routed via one or more registries, each registry being arranged to validate the eligibility of its one or more user terminals to send or receive messages and to notarize the message.

4. A distributed system as claimed in claim 2, wherein the system is arranged such that messages are communicated directly between user terminals, the user terminals comprising means for requesting the registry that it is associated with to validate and notarize messages on request.

5. A distributed system as claimed in claim 2, wherein one of the plurality of registry networks comprises more than one registry, the registries within that registry network being arranged in a hierarchical structure.

6. A distributed system as claimed in claim 1, wherein each user is arranged to be registered with a respective one of the plurality of registries.

7. A distributed system as claimed in claim 1, wherein each registry is associated with a plurality of user terminals.

8. A distributed system as claimed in claim 1, wherein at least one of the user terminals of registered users is arranged to act as a registry.

9. A distributed system as claimed in claim 1, wherein each user's user terminal is arranged to act as a registry.

10. A distributed system as claimed in claim 2, wherein each message comprises an encrypted contents portion and a header portion, the header portion indicating the validity of the contents portion.

11. A distributed system as claimed in claim 10, wherein each user terminal comprises encryption means for encrypting the contents portion with a secret key, the secret key being generated by the user sending the message.

12. A distributed system as claimed in claim 10, wherein the header portion comprises registry generated indication of the validity of the contents portion.

13. A distributed system as claimed in claim 1, wherein the processing means of each registry is arranged to assess the eligibility of the user terminal of each of its registered users to send or receive messages against a predefined set of rules that relate to the use of the system.

14. A distributed system as claimed in claim 13, wherein each registry stores a predefined set of rules, the set of rules being substantially the same for each registry.

15. A distributed system as claimed in claim 1, wherein each registry comprises a data store for storing an original electronic document associated with one of its registered users.

16. A distributed system as claimed in claim 15, wherein the data store of each registry is arranged to store all messages relating to a particular stored electronic document associated with the user terminal of one of its registered users.

17. A distributed system as claims in claim 16, wherein each registry is arranged to manage the access of registered users to a particular stored electronic document and its associated messages.

18. A distributed system as claimed claim 16, wherein each registry is arranged to compile a message history such that all messages relating to a stored electronic document within the registry can be tracked over time.

19. A distributed system as claimed in claim 1, wherein each user terminal and each registry comprises a data store, the original electronic document being stored at a single location within the distributed system and read-only copies of the original electronic document being stored at other locations within the distributed system, each read-only copy comprising a link to the original electronic document.

20. A distributed system as claimed in claim 1, wherein stored electronic documents within the system comprise an original contents portion, corresponding to the contents of the document at the date of the document's issuance, and an endorsement section arranged to record all the messages relating to the document that have been exchanged between user terminals of the system subsequent to the document's issuance.

21. A distributed system as claimed in claim 1, wherein the system comprises multiple copies of an original electronic document, the registries within the system being arranged to monitor messages exchanged between user terminals of the system and to prevent conflicting messages being exchanged in relation to the multiple copies.

22. A distributed system as claimed in claim 1, wherein each registry and user terminal are arranged to exchange messages encrypted using public/private key encryption.

23. A trading system for trading between a plurality of registered users, the system arranged to communicate transactions relating to electronic title documents wherein the system comprises a distributed system as claimed in claim 1.

24. A trading system as claimed in claim 23, wherein the electronic title document is a Bill of Lading.

25. A method for communicating messages between registered users of a distributed system, each registered user communicating with the system via user terminal, the messages relating to an original electronic document that is stored on the system and associated with one of the user terminals, and the system comprising a plurality of registries, each registry having a mutual trust relationship with each of the other registries and being associated with one or more user terminals, being connectable to a data communication network, the method comprising validating the eligibility of each of its registered users' user terminals to send or receive a message relating to the stored electronic document and notarizing each message sent from or received by the user terminal of the registered user, the notarization step indicating the validity of the message relating to the stored document.

26. A distributed system for communicating messages between users of the system, each user communicating with the system via a user terminal, the system comprising means arranged to validate each message sent from or received by a user terminal, and to notarize each message sent from or received by a user terminal, the notarization indicating the validity of the message, wherein each message comprises an encrypted message contents portion and a header portion, the header portion indicating the validity of the message contents portion to a recipient of the message.

27. A distributed system for communicating messages between users of the system as claimed in claim 26, wherein the system comprises a registry for receiving and sending messages between the user terminals, wherein the registry comprises a processing means arranged to validate each message sent from or received by a user terminal, and to notarize each message sent from or received by a user terminal, the notarization indicating the validity of the message.

28. A distribution system as claimed in claim 26, wherein each user terminal comprises encryption means for encrypting the contents portion of each message with a secret key, the secret key being generated by the user sending the message.

29. A distributed system as claimed in claim 28, wherein the messages sent and received by the registry between the user terminals are further encrypted using public/private key encryption.

30. A distributed system as claimed in claim 28, wherein the messages sent and received by the registry between the user terminals are further encrypted using one of biometrics, embedded mutating data elements or validated timestamps.

31. A distributed system as claimed in claim 27, wherein the registry further comprises communication means arranged to connect the registry to further registries, each registry having a mutual trust relationship with each of the other registries.

32. A distributed system as claimed in claim 31, wherein the communication means is arranged to receive notarized messages from other registries, the processing means of the registry being arranged to further notarize the received messages and send the message to the intended recipient's user terminal.

33. A distributed system as claimed in claim 26, wherein each user terminal further comprises means for requesting a decryption code for the encrypted contents portion of a message.

34. A distributed system as claimed in claim 33, wherein the originating user terminal of a message is arranged to provide the decryption code for the message upon receipt of a request from another user terminal.

35. A distributed system as claimed in claim 34, wherein the registry associated with the originating user of the message is arranged to provide the decryption code for the message upon receipt of a request from another user terminal.

36. A distributed system as claimed in claim 26, the system further comprising registration means requiring each user to register and login to the system before sending messages to other users.

37. A method of communicating messages between registered users of a distributed system, each registered user communicating with the system via a user terminal, the system comprising at least one registry for receiving and sending messages between the user terminals, the method comprising validating each message sent from or received by a user terminal, validating each message sent from or received by a user terminal, the notarization indicating the validity of the message wherein each message comprises an encrypted contents portion and a registry portion, the registry portion indicating the validity of the contents portion to a recipient of the message.

38. A registry for communicating messages between users of a distributed system, each user communicating with the system via a user terminal, the registry comprising:
communication means arranged to communicate with at least one user terminal; and
processing means arranged to validate each message received by or sent from the at least one user terminal and to notarize each message received by or sent from that at least one user terminal, the notarization indicating the validity of the received messages;
wherein each message comprises a message contents portion and a registry portion, the registry portion indicating the validity of the message contents portion to a recipient of the message.

39. A registry as claimed in claim 38, wherein the message comprises an encrypted contents portion.

40. A registry as claimed in claim 38, wherein the registry comprises a data store for storing original electronic documents and messages relating to the stored electronic documents.

41. A registry as claimed in claim 38, wherein the registry comprises further communication means arranged to connect the registry to further registries, each registry having a mutual trust relationship with each of the other registries.

42. A method of operating a registry for communicating messages between users of a distributed system, each user communicating with the system via a user terminal, the method comprising:
communicating with at least one user terminal;
validating each message received by or sent from the at least one user terminal;
notarizing each message received by or sent from the at least one user terminal, the notarization indicating the validity of the received messages.
wherein each message comprises a contents portion and a registry portion, the registry portion indicating the validity of the encrypted contents portion to a recipient of the message.

43. A method of identity verification for allowing a first user of a distributed system to verify the identity of a second user of the system, each user of the system having a respective system identity, the distributed system providing a first communications path between the users, the method comprising:
i) requesting the system to generate an authentication code;
ii) providing the authentication code to at least one of the users;
iii) exchanging the authentication code between users' system identities using the first communication path;
iv) exchanging the authentication code between user using a second communication path that is independent of the system and the first communication path; and
v) comparing the authentication codes exchanged in steps (iii) and (iv) in order to verify the identity of the second user of the system.

44. A method of identify verification as claimed in claim 43, wherein step (i) comprises the first user requesting the code; step (ii) comprises the system providing the code from step (i) to the first user; step (iii) comprises the system providing the code from step (i) to the system identity of the second user for retrieval by the second user; in step (iv) the authentication code is sent from the second user to the first user via the second communication path; and step (v) comprises the first user comparing the code received from the system in step (ii) with the code received from the second user in step (iv) and verifying the identity of the second user in the event that the codes match.

45. A method as claimed in claim 43, wherein step (i) comprises the second user of the system requesting the code; step (ii) comprises the system providing the code generated in step (i) to the second user; step (iii) comprises the system providing the code from step (i) to the system identify of the first user; step (iv) comprises the second user sending the code to the first user via the second communications path; and step (v) comprises the first user entering the code received from the second user in step (iv) into the system via its system identity in order to compare the code with the code received by its system identity in step (iii), the identity of the second user being verified in the event that the codes match.

46. A method as claimed in claim 43, wherein step (i) comprises the second user of the system requesting the code, step (ii) comprises the system providing the code generated in step (i) to the second user; step (iii) comprises the system providing the code from step (i) to the system identity of the first user for retrieval by the first user; step (iv) comprises the second user sending the code to the first user via the second communications path; and step (v) comprises the first user comparing the code received from the system in step (iii) with the code received from the second user in step (iv) and verifying the identity of the second user in the event that the codes match.

47. A method as claimed in claim 43, wherein the system randomly generates the authentication code.

48. A method as claimed in claim 43, wherein either the first or second users selects a word or phrase as the authentication code.

49. A method as claimed in claim 43, wherein a telephone or data network provides the second communication path.

50. An electronic title document for use in a distributed system between multiple parties, the system comprising at least one registry having means for validating notarizing the electronic title document, the document comprising:
a header section comprising information relating to the type of electronic document;
a contents section comprising contents information;
an issuer section comprising a digital signature relating to the document's originator;
a registry comprising a digital signature relating to the registry; and
an endorsement section wherein changes relating to the document are recorded.

51. An electronic title document as claimed in claim 50, wherein changes in the endorsement section relate to the ownership of the document.

52. An electronic title document as claimed in claim 50, wherein changes in the endorsement section are transactions relating to the document.

53. An electronic title document as claimed in claim 49, wherein the header and contents sections comprise an encrypted portion encrypted by the issuer of the document and the registry associated with that issue.

54. An electronic title document as claimed in claim 50, wherein the document comprises one or more further sections, each of which is digitally signed by an originator and subsequently the registry.

55. A method of issuing an electronic title document for use in a distributed system between multiple parties, the system comprising at least one registry having means for validating and notarizing the electronic title document, the method comprising:
a document issuer populating a header field comprising information relating to the document type and populating a contents field comprising contents information relating to the document.
digitally signing the header and contents fields by the document issuer;
sending the digitally signed header and contents fields and digital signature from the document issuer to a registry;
validating the information received from the document issuer; and
digitally signing the information validated by the registry.

56. A data carrier comprising a computer program arranged to configure a server to implement the method according to claim 25.

57-58. (canceled)
